(19) United States
(12) Patent Application Publication
(10) Pub. No.: US 2011/0316846 A1
(43) Pub. Date: Dec. 29, 2011

(54) TOUCH PANEL FOR DISPLAYING STEREOSCOPIC IMAGE

(76) Inventors: Chun-Wei Su, Taipei City (TW); Jan-Tien Lien, Keelung City (TW)

(21) Appl. No.: 12/879,022

(22) Filed: Sep. 10, 2010

(30) Foreign Application Priority Data
Jun. 23, 2010 (TW) 099120516

(51) Int. Cl. G06F 3/045; G06T 15/00

(52) U.S. Cl. 345/419; 345/174

(57) ABSTRACT

A touch panel for displaying stereoscopic image includes a substrate, a plurality of first sensing strings, second sensing strings and third sensing strings. Each of the first sensing strings includes a plurality of sensing pads respectively having a first retarder region. The second sensing strings are parallel with the first sensing strings, and each of the second sensing strings includes a plurality of second sensing pads respectively having a second retarder region. The third sensing strings are perpendicular to the first sensing strings and the second sensing strings, and each of the third sensing strings includes a plurality of third sensing pads and fourth sensing pads arranged alternately. Each of the third sensing pads includes the first retarder region and each of the fourth sensing pads includes the second retarder region.

### BACKGROUND OF THE INVENTION

1. Field of the Invention

The present invention is related to a touch panel for displaying stereoscopic image, and to a touch-sensitive liquid crystal display device capable of providing stereoscopic image.

2. Description of the Prior Art

With the progress of display device from black-and-white to color, larger-sized, high-definition, and to flat display, the flat display gradually replaces the conventional cathode ray tube (CRT) display as the color television replaced the black-and-white television previously. Such tendency is the result of pursuing vivid visual experiments. In accordance with such demands, stereoscopic display technique is developed to provide two separate images individually to the left and right eyes of an observer, and thus the observer obtains a stereoscopic vision. Therefore it is always in need to display 3D stereoscopic images in the conventional 2D display environment.

In addition, a touch panel for inputting signals via a display panel has developed to allow a user to select desired information while viewing images without depending on other separate inputting devices such as a keyboard, a mouse or a remote controller. The touch panel therefore meets the demands for user-friendly, simplified and convenient operation of and display.

As mentioned above, the stereoscopic display technology is the result of pursuing specific visual perception and the touch panel is the result of pursuing convenient operation, while both of the approaches are realized in a flat display device. However, the 3D display technology and the touch panel are always individually developed and there still has no display device having the stereoscopic displaying approach and the touch panel approach integrated.

### SUMMARY OF THE INVENTION

Therefore, the present invention provides a touch panel for displaying stereoscopic image and a touch-sensitive liquid crystal display device capable of providing stereoscopic image.

According to a first aspect of the present invention, a touch panel for displaying stereoscopic image is provided. The touch panel for displaying stereoscopic image includes a substrate having a first surface and a second surface, a plurality of first sensing strings, a plurality of second sensing strings and a plurality of third sensing strings. The first sensing strings are positioned on the first surface of the substrate and each of the first sensing strings includes a plurality of sensing pads respectively having a first retarder region. The second sensing strings are parallel with the first sensing strings and positioned on the first surface of the substrate, and each of the second sensing strings includes a plurality of second sensing pads respectively having a second retarder region. The third sensing strings are perpendicular to the first sensing strings and the second sensing strings, and each of the third sensing strings includes a plurality of third sensing pads and fourth sensing pads arranged alternately. Each of the third sensing pads includes the first retarder region and each of the fourth sensing pads includes the second retarder region.

According to the touch panel for displaying stereoscopic image provided by the present invention, the first sensing strings, the second sensing strings and the third sensing strings are able to detect and identify the touch point. Furthermore, the first sensing strings, the second sensing strings and the third sensing strings construct a micro retarder film having a first retarder pattern and a second retarder pattern, accordingly the touch panel is able to provide images respectively to two eyes of a user wearing polarized glasses, therefore 3D images are obtained.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-2 are schematic drawings of a micro retarder film provided by a first preferred embodiment of the present invention, wherein FIG. 1 is a cross-sectional view of the micro retarder film;

FIG. 3 is a schematic drawing of a 2D/3D image displaying system provided by the first preferred embodiment;

FIGS. 4-7 are schematic drawings of a touch panel for displaying stereoscopic image provided by a second preferred embodiment of the present invention, wherein FIG. 4 is a top view of the touch panel, FIG. 5 is a bottom view of the touch panel, FIG. 6 is a perspective drawing of the touch panel, and FIG. 7 is a cross-section view taken along a A-A′ line in FIG. 6; and

FIG. 8 is a schematic drawing of a 2D/3D image displaying system provided by a second preferred embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

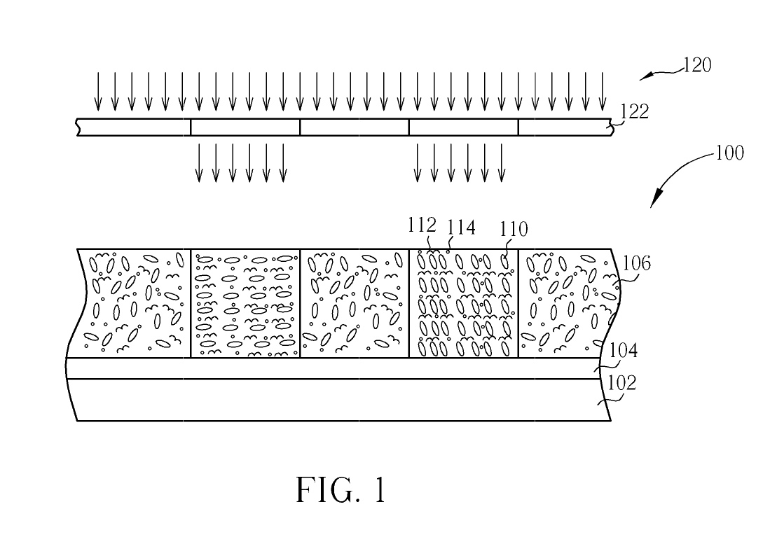

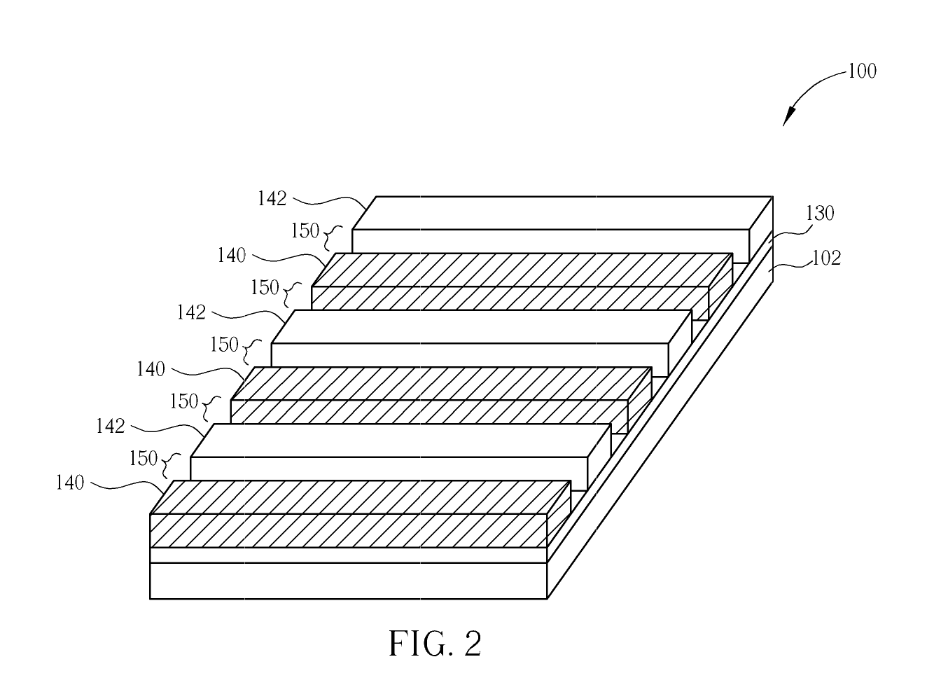

Please refer to FIGS. 1-2, which are schematic drawings of a micro retarder film provided by a first preferred embodiment of the present invention, wherein FIG. 1 is a cross-sectional view of the micro retarder film. As shown in FIG. 1, A micro retarder film 100 provided by the preferred embodiment includes a substrate 102 such as a polyethyleneterephthalate (PET) substrate. The micro retarder film 100 further comprises a polyimide (PI) layer 104 formed on the substrate 102 and a liquid crystal (LC) layer 106 formed on the PI layer 104. It is noteworthy that the LC layer 106 of the micro retarder film 100 includes a plurality of liquid crystal molecules 110, a plurality of photo monomers 112 and a plurality of transparent conductive nanoparticles 114. The transparent conductive nanoparticles 114 can include indium tin oxide (ITO) nanoparticles or indium zinc oxide (IZO) nanoparticles.

As shown in FIGS. 1-2, a photo-alignment treatment 120 is performed to the micro retarder film 100 with employing a photomask 122. The photo-alignment treatment 120 treats the LC layer 106 and the PI layer 104 with an UV light. Therefore the PI layer 104 obtains optical anisotropy and an alignment layer 130 is formed as shown in FIG. 2. After the photo-alignment treatment 120, the transparent conductive nanoparticles 114 are scattered spontaneously and uniformly in the LC layer 106 and the liquid crystal molecules 110 are arranged along with a desired direction, while the transparent conductive nanoparticles 114 and the liquid crystal molecules 110 are polymerized by the photo monomers 112. Accordingly, the micro retarder film 100 having a plurality of the first retarder patterns 140 and a plurality of the second retarder patterns 142 is obtained. Since the photo-alignment treatment 120 is well-known to those skilled in the art, the details are omitted herein in the interest of brevity.

As shown in FIG. 2, the second retarder patterns 142 are parallel with the first retarder patterns 140, and the first retarder patterns 140 and the second retarder patterns 142 are arranged alternately and periodically while the first retarder patterns 140 and the second retarder patterns 142 provides different phase retardations. In this manner, the micro retarder film 100 having alternate phase retardations in a specific strips pattern is obtained. However, it is well-known to those skilled in the art that the patterns and arrangement of the first retarder patterns 140 and the second retarder patterns 142 are not limited to this. Modification to the patterns and arrangement of the first retarder patterns 140 and the second retarder patterns 142 for improving the 3D image can be made while retaining the teachings of the invention. As mentioned above, the first retarder patterns 140 and the second retarder patterns 142 provides different phase retardations, and the phase retardations are designed according to the pixel of a LCD panel. For example, the first retarder pattern 140 has a first retardation amount of zero retardation and the second retarder pattern 142 has a second retardation amount of half-wavelength retardation, but not limited to this.

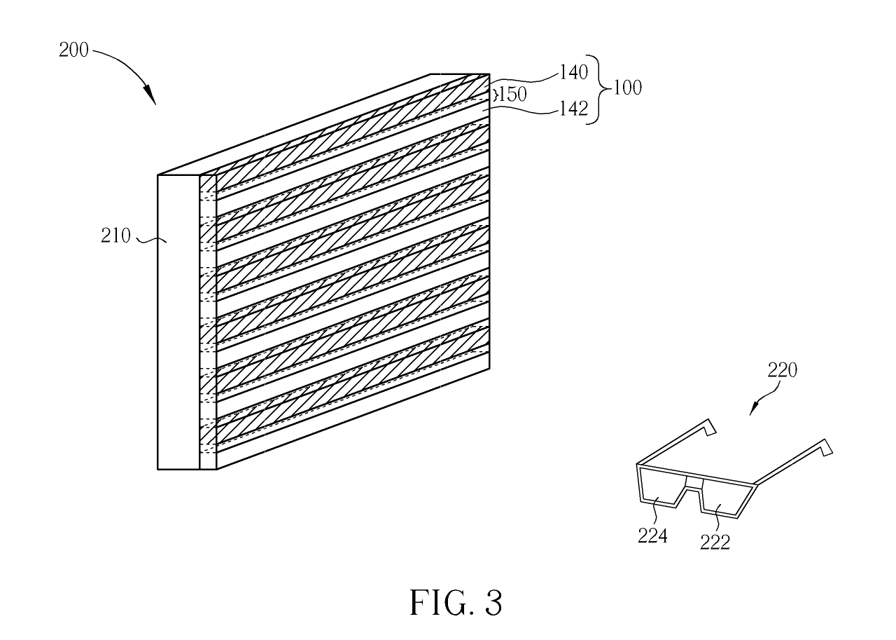

Please refer to FIG. 3, which is a schematic drawing of a 2D/3D image displaying system provided by the first preferred embodiment. As shown in FIG. 3, the 2D/3D image displaying system 200 of the preferred embodiment includes an LCD panel 210, the micro retarder film 100, and polarized glasses 220. The polarized glasses 220 include a left-eye polarizer 222 and a right-eye polarizer 224. As shown in FIG. 3, the micro retarder film 100 is attached to the LCD device 210 with the first retarder pattern 140 and the second retarder pattern 142 arranged parallel with a horizontal direction. According to the 2D/3D image displaying system 200 of the preferred embodiment, 2D images are provided in conventional 2D observe mode. And in 3D observe mode, the 2D/3D image displaying system 200 provides a 3D image therefore the user wearing the polarized glasses 220 obtains 3D images: the left-eye polarizer 222 of the polarized glasses 220 allows lights passing through the first retarder patterns 140 enter the left eye of the user and the right-eye polarizer 224 allows lights passing through the second retarder patterns 142 enter the right eye of the user. And thus the user obtains a stereoscopic vision.

Please refer to FIGS. 1-3 again. It is noteworthy that since the photo-alignment treatment 120 is performed with the photomask 122, the portions of the micro retarder film 100 that not exposed to UV are removed by organic solvent after the photo-alignment treatment 120. Therefore any adjacent first retarder pattern 140 and the second retarder pattern 142 include a pitch 150 formed therebetween. A width of the pitch 150 is adjustable according to a black matrix. Compared with the conventional micro retarder film that has no pitch between different retarder patterns, the pitch 150 between the adjacent first retarder pattern 140 and second retarder pattern 142 eliminates the image interference from different image information provided to different eyes. Therefore ghost images that always found in conventional micro retarder film, which has no pitch between different retarder patterns, are prevented.

In the preferred embodiment, the first retarder patterns 140 and the second retarder patterns 142 of the micro retarder film 100 both include the transparent conductive nanoparticles 114, therefore the micro retarder film 100 is taken as a capacitive touch panel with the first retarder patterns 140 and the second retarder patterns 142 serve as the sensing strings of the capacitive touch panel. By detecting the change in the capacitance between the first retarder patterns 140, the second retarder patterns 142 and human body, the touch point can be easily identified. As shown in FIG. 3, since the first retarder patterns 140 and the second retarder patterns 142 are arranged parallel with a same direction, the capacitive touch panel of the preferred embodiment is an one-dimension touch panel.

In other words, the preferred embodiment provides an one-dimension touch panel 100 includes the first retarder patterns 140 and the second retarder patterns 142 that are arranged alternately and serve as the sensing strings. And the touch panel 100 of the preferred embodiment further provides different phase retardations and thus serves as a micro retarder film. Therefore, when the touch panel 100 is attached to a side of the LCD panel 210, the 2D/3D image displaying system 200 is obtained: when the 2D/3D image displaying system 200 is in 2D observe mode, it provides both 2D image and touch-control function; when the 2D/3D image displaying system 200 is in 3D observe mode, the touch panel 100 serving as the micro retarder film further provides function of wavelength retardation. Therefore user wearing the polarized glasses 220 obtains high-definition 3D images without interference. Briefly speaking, the preferred embodiment integrates the micro retarder film and the touch panel without complicating manufacturing processes. And when the touch panel 100 is attached to the conventional display panel, it successfully provides not only the touch-control function but also the function of wavelength retardation.

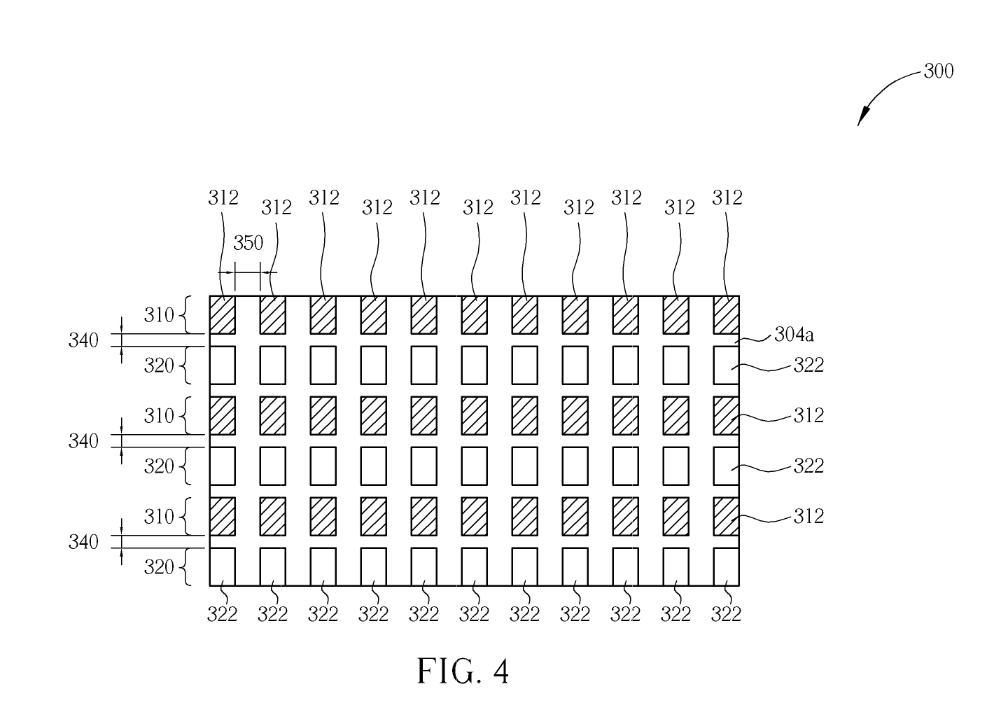

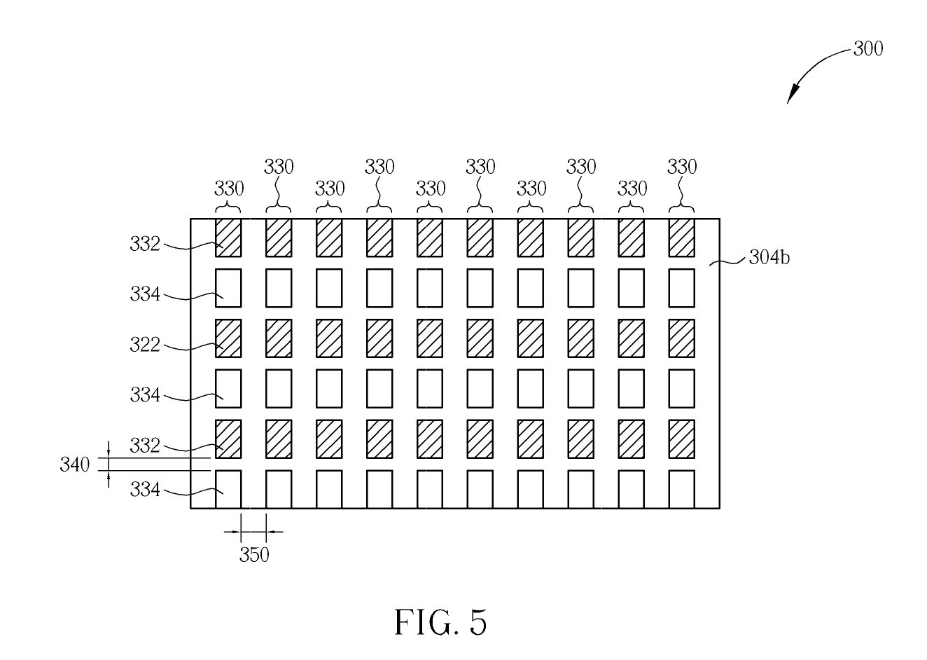

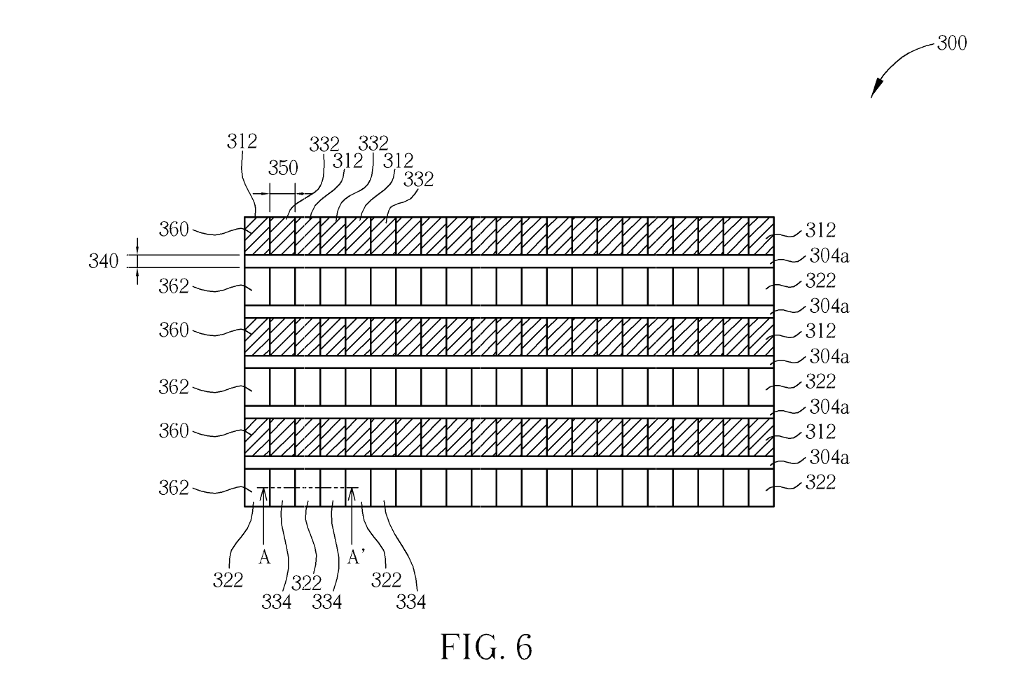

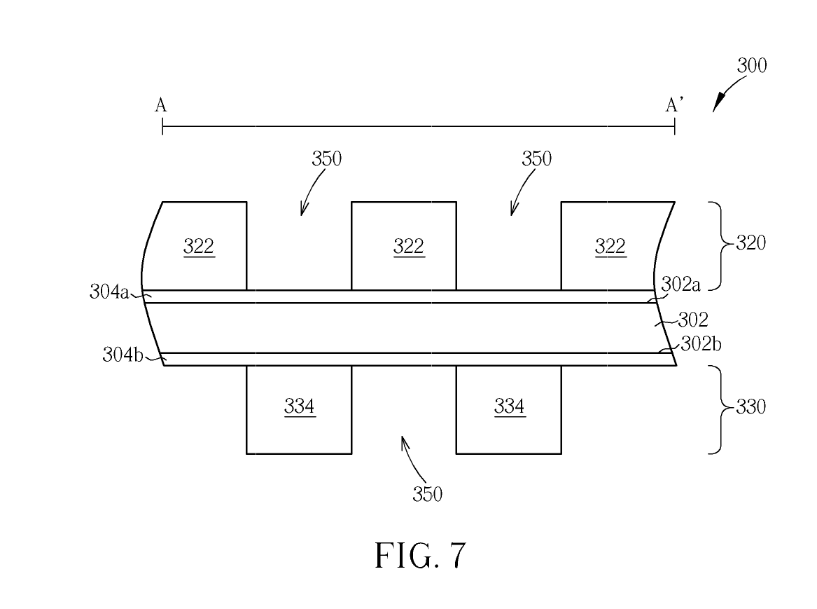

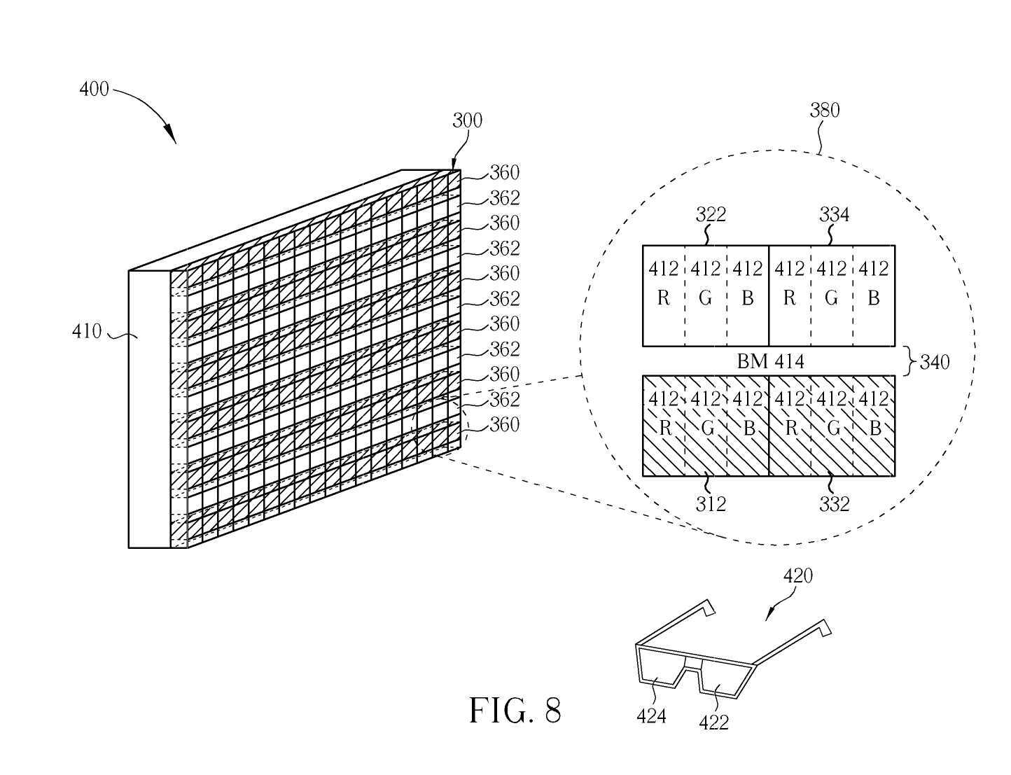

Please refer to FIGS. 4-7, which are schematic drawings of a touch panel for displaying stereoscopic image provided by a second preferred embodiment of the present invention, wherein FIG. 4 is a top view of the touch panel, FIG. 5 is a bottom view of the touch panel, FIG. 6 is a perspective drawing of the touch panel, and FIG. 7 is a cross-sectional view taken along a A-A′ line in FIG. 6. Please refer to FIG. 4 and FIG. 7. The touch panel 300 provided by the preferred embodiment includes a substrate 302 such as a PET substrate, and the substrate 302 includes a first surface 302a and a second surface 302b. An alignment layer 304a, a plurality of first sensing strings 310 and a plurality of second sensing strings 320 are formed on the first surface 302a of the substrate 302. The first sensing strings 310 and the second sensing strings 320 are formed as described in the first preferred embodiment: firstly, a PI layer (not shown) is formed on the first surface 302a and a LC layer (not shown) having a plurality of liquid crystal molecules, a plurality of photo monomers and a plurality of transparent conductive nanoparticles is sequentially formed on the PI layer. Then, a photo-alignment treatment is performed to the PI layer and the LC layer and followed by removing portions of the LC layer that not exposed to the photo-alignment treatment. Therefore, the alignment layer 304a, the first sensing strings 310 and the second sensing strings 320 are formed as shown in FIG. 4 and FIG. 7. It is noteworthy that the first sensing strings 310 and the second sensing strings 320 are parallel with each other and alternately arranged. Furthermore, the adjacent first sensing string 310 and second sensing string 320 further include a pitch 340 therebetween as shown in FIG. 4 and FIG. 8. A width of the pitch 340 is adjustable according to a black matrix 414 (shown in the circle 380 designated in FIG. 8) of a LCD panel 410, but not limited to this.

Please still refer to FIG. 4 and FIG. 7. Each first sensing string 310 includes a plurality of first sensing pads 312 and each second sensing string 320 includes a plurality of second sensing pads 322. The first sensing pads 312 are electrically connected to each other respectively by a bridging electrode (not shown) and the second sensing pads 322 are electrically connected to each other respectively by another bridging electrode (not shown). Since the first sensing pads 312 and the second sensing pads 322 are formed by photo-alignment treatment as mentioned in the first preferred embodiment, the liquid crystal molecules in the first sensing pads 312 are arranged along with a desired direction. Thus the first sensing pads 312 respectively include a first retarder region. In the same concept, the second sensing pads 320 respectively include a second retarder region. As shown in FIG. 4 and FIG. 7, each of the first sensing pads 312 includes a gap 350 formed therebetween and each of the second sensing pads 322 also includes the gap 350 formed therebetween. It is noteworthy that the first sensing pads 312, the second sensing pads 322 and the gaps 350 all have the same size and that is adjustable according to a pixel of a LCD panel. For example, the sizes of the first sensing pads 312, the second sensing pads 322 and the gaps 350 are the same with that of pixel regions 412R/412G/412B of the LCD panel 410 as shown in circle 380 in FIG. 8.

Please refer to FIG. 5 and FIG. 7. An alignment layer 304b and a plurality of third sensing strings 330 perpendicular to the first sensing strings 310 and the second sensing strings 320 are sequentially formed on the second surface 302b of the substrate 302. Each third sensing string 330 includes a plurality of third sensing pads 332 and a plurality of fourth sensing pads 334 arranged alternately. The adjacent third sensing pad 332 and fourth sensing pad 334 include the pitch 340 formed therebetween and the pitch 340 is corresponding to the black matrix of the LCD panel. The third sensing pads 332 and the fourth sensing pads 334 are connected to each other respectively by a bridging electrode (not shown). The third sensing strings 330 are formed by the photo-alignment treatment as mentioned in the first preferred embodiment, therefore the third sensing pads 332 respectively include the first retarder region and the fourth sensing pads 334 respectively include the second retarder region. It is noteworthy that each of the third sensing strings 330 includes the gap 350 formed therebetween. The third sensing pads 332 and the fourth sensing pads 334 are arranged corresponding to the gap 350 between the first sensing pads 312 and between the second sensing pads 322. In detail, the third sensing pads 332 are positioned corresponding to the gap 350 between the first sensing pads 312 and the fourth sensing pads 334 are positioned corresponding to the gap 350 between the second sensing pads 322.

According to the touch panel 300 for displaying stereoscopic image provided by the preferred embodiment, the first sensing strings 310 and the second sensing strings 320 are positioned on the first surface 302a of the substrate 302, therefore the touch point is identified by the first sensing pads 312 and the second sensing pads 322 by detecting change in the capacitance on the first surface 302a. In other words, the first sensing strings 310 and the second sensing strings 320 are used to detect the touch point in a first direction such as a horizontal direction. The third sensing strings 330 are positioned on the second surface 302b of substrate 302, therefore the third sensing pads 332 and the fourth sensing pads 334 are used to detect the touch point in a second direction such as the vertical direction. Accordingly, the capacitive touch panel 300 of the preferred embodiment provides a two-dimension touch-control function, that is, to provide the multi-touch control function.

In the preferred embodiment, the first sensing pads 312, the second sensing pads 322, the third sensing pads 332 and the fourth sensing pads 334 are formed in rectangle shape, but not limited to this. For example, the first sensing pads 312, the second sensing pads 322, the third sensing pads 332 and the fourth sensing pads 334 of the preferred embodiment can be formed in conventional rhombus shape. In addition, in the preferred embodiment, the first sensing strings 310 and the second sensing strings 320 are positioned on the first surface 302a while the third sensing strings 330 are positioned on the second surface 302b. However, it is not limited to position the first sensing strings 310, the second sensing strings 320, and the third sensing strings 330 all on the first surface 302a.

Please refer to FIG. 6. The first sensing strings 310 and the second sensing strings 320 positioned on the first surface 302a and the third sensing strings 330 positioned on the second surface 302b are superimposed as shown in FIG. 6: the first sensing pads 312, the second sensing pads 322, the third sensing pads 332 and the fourth sensing pads 334 are positioned in a matrix. The first sensing pads 312 and the third sensing pads 332 are positioned in a same row to form a first retarder pattern 360 while the second sensing pads 322 and the fourth sensing pads 334 are positioned in a same row to form a second retarder pattern 362. And the adjacent first retarder pattern 360 and second retarder pattern 362 includes the pitch 340 therebetween. As shown in FIG. 6, the first retarder patterns 360 and the second retarder patterns 362 of the touch panel 300 for displaying stereoscopic image of the preferred embodiment are alternately positioned. As mentioned above, the first retarder patterns 360 and the second retarder patterns 362 provide different phase retardations, and the phase retardations are designed according to the pixel of the LCD panel. For example, the first retarder pattern 360 has a first retardation amount of zero retardation and the second retarder pattern 362 has a second retardation amount of half-wavelength retardation. Accordingly, the touch panel 300 of the preferred embodiment further serves as a micro retarder film that provides a function of wavelength retardation.

Please refer to FIG. 8, which is a schematic drawing of a 2D/3D image displaying system provided by the second preferred embodiment of the present invention. The 2D/3D image displaying system 400 of the preferred embodiment includes a LCD panel 410, the touch panel 300, and polarized glasses 420. The polarized glasses 420 include a left-eye polarizer 422 and a right-eye polarizer 424. As shown in FIG. 8, the touch panel 300 is attached to a side of the LCD device 410 with the first retarder patterns 360 and the second retarder patterns 362 arranged parallel with a horizontal direction. According to the 2D/3D image displaying system 400 of the preferred embodiment, 2D images are provided in conventional 2D observe mode. And in 3D observe mode, the 2D/3D image displaying system 400 provides a 3D image therefore the user wearing the polarized glasses 420 obtains 3D images: the left-eye polarizer 422 of the polarized glasses 420 allows lights passing through the first retarder patterns 360 enter the left eye of the user and the right-eye polarizer 424 allows lights passing through the second retarder patterns 362 enter the right eye of the user. And thus the user obtains a stereoscopic vision. Furthermore, since the first retarder pattern 360 and the second retarder pattern 362 include the pitch 340 therebetween, the problem of ghost image due interference from different eyes is prevented.

Accordingly, the touch panel 300 for displaying stereoscopic image provided by the preferred embodiment is a capacitive touch panel utilizing the first sensing strings 310 and the second sensing strings 320 to identify touch point in horizontal direction and the third sensing strings 330 to identify touch point in vertical direction, and thus to provide multi-touch control function. Furthermore, since the first sensing strings 310, the second sensing strings 320, and the third sensing strings 330 are superimposed to form the first retarder patterns 360 and the second retarder patterns 362, the touch panel 300 of the preferred embodiment further serves as the micro retarder film that provides function of wavelength retardation. When the touch panel 300 is attached to the LCD panel 410, the 2D/3D image displaying system 400 is obtained: when the 2D/3D image displaying system 400 is in 2D observe mode, it provides both 2D image and touch-control function; when the 2D/3D image displaying system 400 is in 3D observe mode, the touch panel 300 serving as the micro retarder film further provides function of wavelength retardation. Therefore the user wearing the polarized glasses 220 obtains high-definition 3D images without interference. Briefly speaking, the preferred embodiment integrates the micro retarder film and the touch panel without complicating manufacturing processes. And when the touch panel 300 is attached to the conventional display panel, it successfully provides not only the touch-control function but also the function of wavelength retardation.

According to the touch panel for displaying stereoscopic image and the touch-sensitive LCD device capable of providing stereoscopic image provided by the present invention, the first sensing strings, the second sensing strings and the third sensing strings are able to detect and identify the touch point. Furthermore, since the first sensing strings, the second sensing strings and the third sensing strings construct the micro retarder film having the first retarder patterns and the second retarder patterns, the touch panel is able to provide images respectively to two eyes of a user wearing polarized glasses, therefore 3D images are obtained.

Those skilled in the art will readily observe that numerous modifications and alterations of the device and method may be made while retaining the teachings of the invention.

What is claimed is:

1. A touch panel for displaying stereoscopic image comprising:
a substrate having a first surface and a second surface;
a plurality of first sensing strings positioned on the first surface of the substrate, each of the first sensing strings comprising a plurality of first sensing pads respectively having a first retarder region;
a plurality of second sensing strings parallel with the first sensing strings positioned on the first surface of the substrate, each of the second sensing strings comprising a plurality of second sensing pads respectively having a second retarder region; and
a plurality of third sensing strings perpendicular to the first sensing strings and the second sensing strings positioned on the substrate, each of the third sensing strings comprising a plurality of third sensing pads respectively having the first retarder region and fourth sensing pads respectively having the second retarder region alternately arranged.

2. The touch panel for displaying stereoscopic image of claim 1, wherein the first sensing pads, the second sensing pads, the third sensing pads, and the fourth sensing pads are positioned in a matrix.

3. The touch panel for displaying stereoscopic image of claim 2, wherein the first sensing pads and the third sensing pads are positioned in a same row to form a first retarder pattern.

4. The touch panel for displaying stereoscopic image of claim 2, wherein the second sensing pads and the fourth sensing pads are positioned in a same row to form a second retarder pattern.

5. The touch panel for displaying stereoscopic image of claim 1, further comprising a pitch formed between the first sensing string and the second sensing string.

6. The touch panel for displaying stereoscopic image of claim 5, further comprising the pitch positioned between the third sensing pad and the fourth sensing pad.

7. The touch panel for displaying stereoscopic image of claim 1, wherein the third sensing strings are positioned on the second surface of the substrate.

8. The touch panel for displaying stereoscopic image of claim 1, wherein each of the first sensing pads comprises a gap formed therebetween and each of the second sensing pads comprises the gap formed therebetween.

9. The touch panel for displaying stereoscopic image of claim 8, wherein the third sensing pads are corresponding to the gap between the first sensing pads and the fourth sensing pads are corresponding to the gap between the second sensing pads.

10. The touch panel for displaying stereoscopic image of claim 1, wherein the first sensing pads, the second sensing pads, the third sensing pads and the fourth sensing pads comprise a plurality of liquid crystal molecules, a plurality photo monomers and a plurality of transparent conductive nanoparticles.
